(19) United States
(12) Patent Application Publication
(10) Pub. No.: US 2021/0377250 A1
(43) Pub. Date: Dec. 2, 2021

(54) AUTHENTICATION SYSTEM, DEVICE, AND AUTHENTICATION METHOD

(71) Applicant: Keiichiro Hitomi, TOKYO (JP)

(72) Inventor: Keiichiro Hitomi, TOKYO (JP)

(73) Assignee: Ricoh Company, Ltd., Tokyo (JP)

(21) Appl. No.: 17/315,555

(22) Filed: May 10, 2021

(30) Foreign Application Priority Data
May 29, 2020 (JP) 2020-095034

(51) Int. Cl. H04L 29/06

(52) U.S. Cl. CPC H04L 63/083; H04L 63/20; H04L 63/102

(57) ABSTRACT

An authentication system includes a device and at least one information processing apparatus connected to the device via a network. The information processing apparatus includes one or more memories and first circuitry. The one or more memories store user information and setting information indicating whether omission of a password is permitted in authentication. The first circuitry receives, from the device, an authentication request signal that includes an identifier for identifying a user but does not include a password. The first circuitry, in response to the setting information indicating that omission of the password is permitted and in response to the user information including information on the user identified by the identifier, transmits information indicating successful authentication to the device. The device includes second circuitry that transmits, to the information processing apparatus, the authentication request signal that includes an identifier for identifying a user but does not include a password.

### CROSS-REFERENCE TO RELATED APPLICATIONS

This patent application is based on and claims priority pursuant to 35 U.S.C. § 119(a) to Japanese Patent Application No. 2020-095034, filed on May 29, 2020, in the Japan Patent Office, the entire disclosure of which is hereby incorporated by reference herein.

### BACKGROUND

### Technical Field

The present disclosure relates to an authentication system, a device, and an authentication method.

### Description of the Related Art

Devices that are used by a plurality of users and perform user authentication to restrict available functions or limit accessible resources on a user-by-user basis are developed.

For example, a system that stores a persistent file such as a cookie or a flash object file in a terminal used by a user and that uses the file in authentication of the user is disclosed.

In a system in which user authentication is performed, there is a case where an influence of erroneous authentication of a user or spoofing is small. In such a case, an authentication operation performed by a user is desirably simplified. However, with the aforementioned technique of the related art, it is difficult to implement a simplified authentication operation in a device used by a plurality of users.

### SUMMARY

A disclosed technique is an authentication system including a device; and at least one information processing apparatus connected to the device via a network. The information processing apparatus includes one or more memories and first circuitry. The one or more memories store user information and setting information that indicates whether omission of a password is permitted in authentication. The first circuitry receives, from the device, an authentication request signal that includes an identifier for identifying a user but does not include a password. The first circuitry, in response to the setting information indicating that omission of the password is permitted and in response to the user information including information on the user identified by the identifier, transmits information indicating successful authentication to the device. The device includes second circuitry. The second circuitry transmits, to the information processing apparatus, the authentication request signal that includes an identifier for identifying a user but does not include a password.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of a configuration of an authentication system;

FIG. 2 is a block diagram illustrating an example of a hardware configuration of an image forming apparatus;

FIG. 3 is a block diagram illustrating an example of a hardware configuration of an information processing apparatus;

FIG. 4 is a block diagram for describing an example of functions of the image forming apparatus;

FIG. 5 is a diagram illustrating an example of an authentication method setting screen;

FIG. 6 is a sequence diagram illustrating an example of a main-body-authentication-screen display process;

FIG. 7 is a diagram illustrating an example of a main body authentication screen;

FIG. 8 is a sequence diagram illustrating an example of a user information update process;

FIG. 9 is a sequence diagram illustrating an example of a main body authentication process;

FIG. 10 is a diagram illustrating an example of a password input screen;

FIG. 11 is a diagram illustrating an example of a home screen; and

FIG. 12 is a diagram illustrating an example of an authentication error screen.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Embodiment

An authentication system according to an embodiment of the present disclosure will be described below with reference to the accompanying drawings.

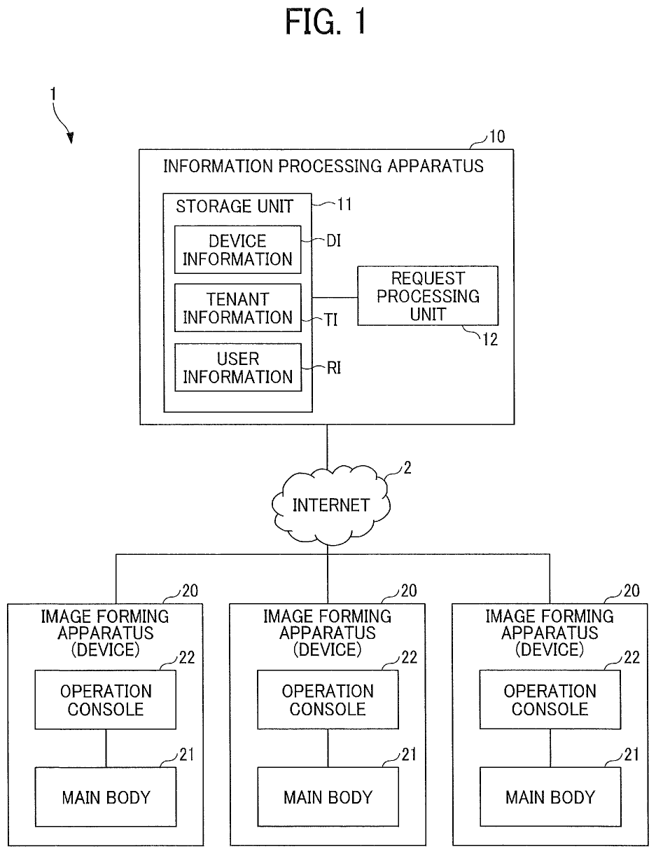

FIG. 1 is a schematic diagram illustrating an example of a configuration of an authentication system.

As illustrated in FIG. 1, an authentication system 1 includes an information processing apparatus 10 and one or a plurality of image forming apparatuses 20.

The information processing apparatus 10 is connected to each of the one or plurality of image forming apparatuses 20 via Internet 2 to be able to communicate with each other. The information processing apparatus 10 functions as a web server that provides the image forming apparatuses 20 with various functions such as an authentication function, a tenant information management function, a device information management function, a user information management function, a screen information management function, a file management function, and other cooperative functions. The information processing apparatus 10 may be replaced with an information processing system including a plurality of information processing apparatuses. In such a case, the plurality of information processing apparatuses have the various functions of the information processing apparatus 10 in a distributed manner, so that the various functions are implemented by the entire information processing system.

The image forming apparatus 20 is an example of a device that communicates with the information processing apparatus 10. The image forming apparatus 20 is a device that implements image forming functions such as scanning, printing, and copying. In addition to implementing the image forming functions by itself, the image forming apparatus 20 functions as a web client that uses the various functions provided by the information processing apparatus 10.

The Internet 2 is an example of a wireless or wired communication network, and may be replaced with a local area network (LAN), a wide area network (WAN), a virtual private network (VPN), or the like.

For example, the information processing apparatus 10 executes a web application program (hereinafter, referred to as a web app) to allow the image forming apparatus 20 to form images from files stored in various cloud servers connected via the Internet 2. A web app is an application program that defines a function to be provided to the image forming apparatus 20 serving as a web client by the information processing apparatus 10 serving as a web server.

The image forming apparatus 20 has a main body authentication function for performing authentication of a user who is to use the image forming functions such as scanning, printing, and copying. That is, main body authentication is authentication for permitting the use of the functions of the image forming apparatus 20.

Examples of authentication information to be input by a user subjected to authentication performed by the image forming apparatus 20 include user information such as an identifier (ID) and a password manually input via an operation panel of the image forming apparatus 20, ID information input through a contact of an integrated circuit (IC) card to an IC card reader of the image forming apparatus 20, and image information or biometric information obtained through image-based authentication or biometric authentication performed by the image forming apparatus 20. Such authentication information is compared with user information registered in the image forming apparatus 20 or an external apparatus. If association between the authentication information and the user information is confirmed, authentication is successful. The image forming apparatus 20 accepts input of the authentication information for use in any of the authentication methods, with an authentication screen being displayed. In this manner, the image forming apparatus 20 is able to request or start an authentication process that is performed in or outside the image forming apparatus 20.

The image forming apparatus 20 is capable of setting a main body authentication setting between enabled (ON) or disabled (OFF). The main body authentication setting is a setting indicating whether to use the main body authentication function.

When the main body authentication setting is ON, the image forming apparatus 20 performs main body authentication. If the main body authentication is successful, the image forming apparatus 20 permits the user to perform an image forming process. When the main body authentication setting is OFF, the image forming apparatus 20 permits the user to perform an image forming process without performing main body authentication.

When the main body authentication setting is ON, either standard authentication or system authentication is further set. The standard authentication is an authentication method in which the image forming apparatus 20 performs authentication by itself. The system authentication is an authentication method in which the image forming apparatus 20 uses, via a network, an authentication function provided by an entity outside the image forming apparatus 20. Examples of the entity include an authentication server that provides an authentication function serving as authentication infrastructure used by each function in or outside the information processing apparatus 10, and an authentication service provided in an external web service such as groupware.

Specifically, the information processing apparatus 10 includes a storage unit 11 and a request processing unit 12.

The storage unit 11 stores various kinds of information such as device information DI, tenant information TI, and user information RI.

The various kinds of information such as the device information DI, the tenant information TI, and the user information RI are pieces of information used in main body authentication.

The request processing unit 12 performs various processes in accordance with request signals transmitted from the image forming apparatus 20. Specifically, the request processing unit 12 receives, from the image forming apparatus 20, an authentication request signal that includes an identifier for identifying a user but does not include a password. If authentication setting information included in the tenant information TI indicates that omission of a password is permitted and if information on the user identified by the identifier is included in the user information RI, the request processing unit 12 transmits information indicating successful authentication to the image forming apparatus 20.

The image forming apparatus 20 includes a main body 21 and an operation console 22.

The main body 21 implements image forming functions such as copying, scanning, and printing, that is, functions of the image forming apparatus 20.

The operation console 22 accepts a user operation and instructs the main body 21 to perform various processes. The operation console 22 includes an interface to be operated to select an application program to be started. Application programs include a native app and a browser app.

A native app is an application program that defines a process performed by the image forming apparatus 20 by itself. A native app is executed in response to the above-described main body authentication being successful. An authentication application for performing the main body authentication or the like may be implemented as a native app.

A browser app is an application program that implements a web browser function. A browser app (web browser application) implements a function of displaying a result of a process defined by a web app and performed by the information processing apparatus 10, and transmitting, in response to a user operation, information on the operation to the information processing apparatus 10.

A hardware configuration of each of the apparatuses included in the authentication system 1 according to the embodiment will be described next.

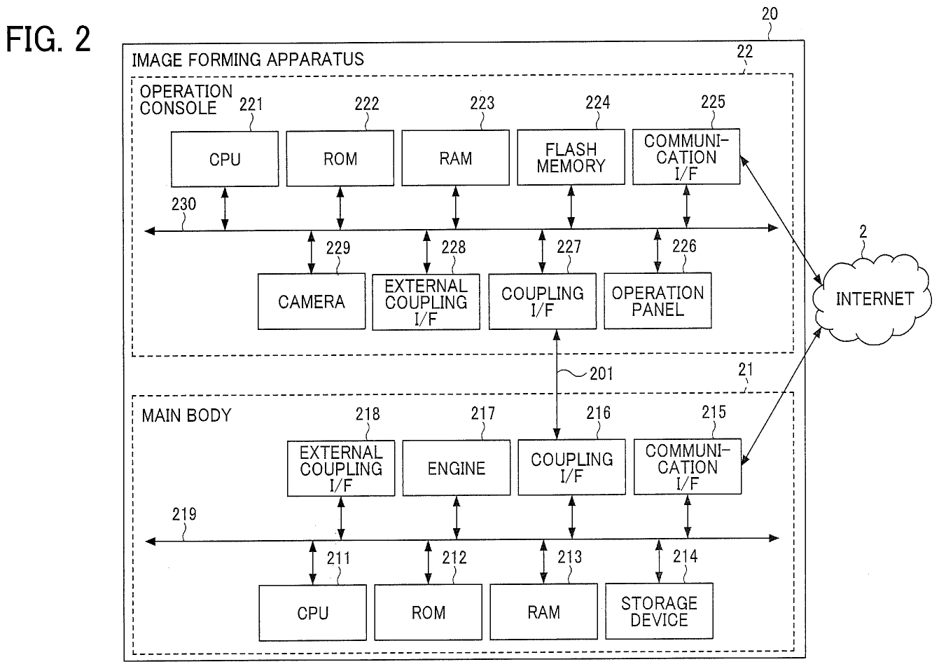

FIG. 2 is a block diagram illustrating an example of a hardware configuration of the image forming apparatus.

The image forming apparatus 20 includes the main body 21 that implements image forming functions, and the operation console 22 that accepts a user operation. The expression “to accept a user operation” is a concept including accepting information input in response to the user operation. The information may include a signal indicating coordinate values on a screen.

The main body 21 and the operation console 22 are coupled to each other via a communication channel 201 to be able to communicate with each other. The communication channel 201 conforming to, for example, the Universal Serial Bus (USB) standard may be used. The communication channel 201 may conform to any wired or wireless standard other than the USB standard.

The main body 21 includes a central processing unit (CPU) 211, a read-only memory (ROM) 212, a random access memory (RAM) 213, a storage device 214, a communication interface (I/F) 215, a coupling I/F 216, an engine 217, an external coupling I/F 218, and a system bus 219, for example.

The CPU 211 is an arithmetic device that uses the RAM 213 as a work area to execute a program stored in the ROM 212, the storage device 214, or the like, and to consequently control operations of the entire main body 21. For example, the CPU 211 uses the engine 217 to implement various functions such as copying, scanning, faxing, and printing.

The ROM 212 is, for example, a nonvolatile memory that stores a basic input/output system (BIOS) executed at the time of booting the main body 21, various settings, and so on. The RAM 213 is a volatile memory used as a work area of the CPU 211. The storage device 214 is, for example, a nonvolatile storage device that stores an operating system (OS), an application program, various kinds of data, and so on. The storage device 214 may be, for example, a hard disk drive (HDD) or a solid state drive (SSD).

The communication I/F 215 is a network interface that connects the main body 21 to the Internet 2 to enable communication with an external apparatus. The communication I/F 215 may be a network interface for a wireless LAN, a wired LAN, or the like. The coupling I/F 216 is an interface that enables communication between the main body 21 and the operation console 22 via the communication channel 201.

The engine 217 is hardware that performs processing for implementing functions of copying, scanning, faxing, printing, and so on. The engine 217 performs processing other than general information processing and other than processing for communication. The engine 217 includes, for example, a scanner (image reading device) that scans and reads an image of a document, a plotter (image forming device) that prints an image on a sheet member such as paper, and a fax device that performs facsimile communication. The engine 217 may further include a finisher that sorts printed sheet materials, and a particular optional device such as an automatic document feeder (ADF) that automatically feeds the documents.

The external coupling I/F 218 is an interface that couples an external device to the main body 21. Examples of the external device include an IC card reader and a moving object sensor. The system bus 219 is coupled to the above-described components and transfers address signals, data signals, and various control signals.

The operation console 22 includes a CPU 221, a ROM 222, a RAM 223, a flash memory 224, a communication I/F 225, an operation panel 226, a coupling I/F 227, an external coupling I/F 228, a camera 229, and a system bus 230, for example.

The CPU 221 is an arithmetic device that uses the RAM 223 as a work area to execute a program stored in the ROM 222, the flash memory 224, or the like and to consequently control operations of the entire operation console 22. The ROM 222 is, for example, a nonvolatile memory that stores a BIOS executed at the time of booting the operation console 22, various settings, and so on. The RAM 223 is a volatile memory used as a work area of the CPU 221. The flash memory 224 is, for example, a nonvolatile storage device that stores an OS, an application program, and various kinds of data.

The communication I/F 225 is a network interface that connects the operation console 22 to the Internet 2 to enable communication with an external apparatus. The communication I/F 225 may be a network interface for a wireless LAN, a wired LAN, or the like.

The operation panel 226 accepts various inputs corresponding to user operations and displays various kinds of information. The operation panel 226 is implemented by, but not limited to, a liquid crystal display (LCD) having a touch panel function, for example. The operation panel 226 may be implemented by, for example, an organic electro luminescence (EL) display having a touch panel function. As an alternative to or in addition to the LCD or the organic EL display, the operation panel 226 may include an operation device with hardware buttons and the like, and an indicator such as a lamp.

The coupling I/F 227 is an interface that enables communication between the operation console 22 and the main body 21 via the communication channel 201. The external coupling I/F 228 is an interface that couples an external device to the operation console 22. Examples of the external coupling I/F 228 include a USB interface.

The camera 229 is an image capturing apparatus that captures an image of a user. The camera 229 may be outside the image forming apparatus 20 and be coupled to the operation console 22 via the external coupling I/F 228. The system bus 230 is coupled to the above-described components and transfers address signals, data signals, and various control signals.

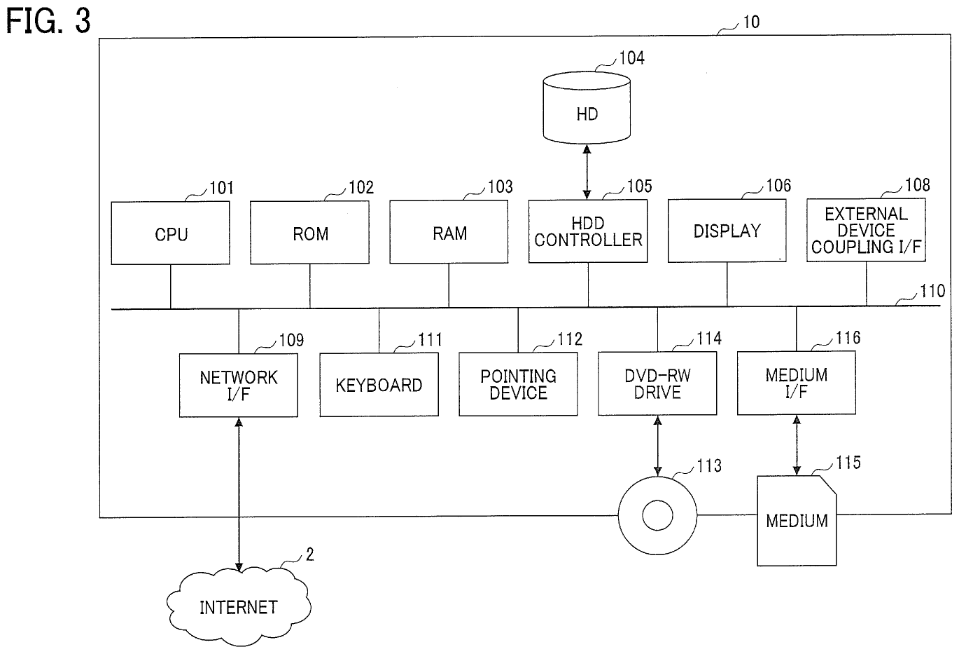

FIG. 3 is a block diagram illustrating an example of a hardware configuration of the information processing apparatus.

The information processing apparatus 10 is constituted by a computer. The information processing apparatus 10 includes a CPU 101, a ROM 102, a RAM 103, a hard disk (HD) 104, an HDD controller 105, a display 106, an external device coupling I/F 108, a network I/F 109, a bus line 110, a keyboard 111, a pointing device 112, a digital versatile disc-rewritable (DVD-RW) drive 114, and a medium I/F 116.

The CPU 101 controls operations of the entire information processing apparatus 10. The ROM 102 stores a program such as an Initial Program Loader (IPL) used for driving the CPU 101. The RAM 103 is used as a work area of the CPU 101. The HD 104 stores a program such as a guest network creation application, and various kinds of data. The HDD controller 105 controls reading of various kinds of data from or writing of various kinds of data to the HD 104 under control of the CPU 101. The display 106 displays various kinds of information such as a cursor, a menu, a window, characters, or an image.

The external device coupling I/F 108 is an interface that couples various external devices to the information processing apparatus 10. In this case, the external devices may be, for example, devices such as a USB memory and a printer. The network I/F 109 is an interface that enables data communication between the information processing apparatus 10 and the image forming apparatus 20 or the like via the Internet 2. The bus line 110 is a bus such as an address bus or a data bus that electrically couples the components such as the CPU 101 illustrated in FIG. 3 to one another.

The keyboard 111 is an example of an input device including a plurality of buttons that allow a user to input characters, numerals, and various instructions, for example. The pointing device 112 is an example of an input device that allows a user to select or execute various instructions, select a processing target, and move a cursor, for example. The DVD-RW drive 114 controls reading of various kinds of data from or writing of various kinds of data to a DVD-RW 113, which is an example of a removable recording medium. The removable recording medium is not limited to the DVD-RW and may be a digital versatile disc-recordable (DVD-R) or the like. The medium I/F 116 controls reading of data from or writing (storing) of data to a medium 115 such as a flash memory.

Functions of the image forming apparatus 20 will be described next.

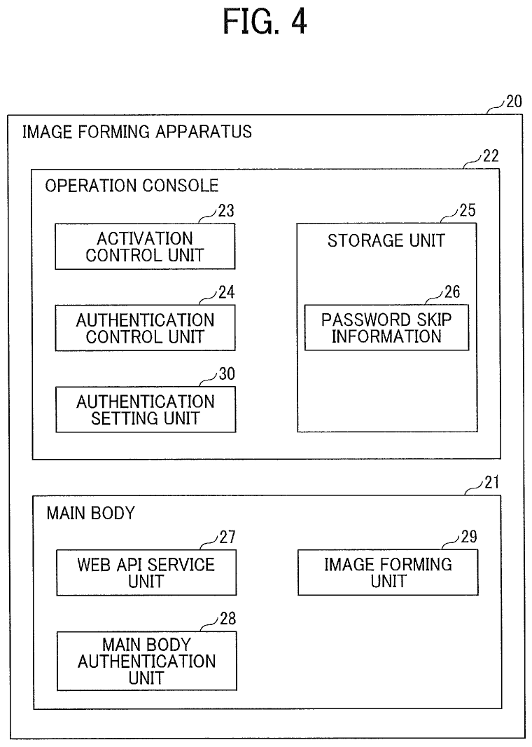

FIG. 4 is a block diagram for describing an example of functions of the image forming apparatus.

The image forming apparatus 20 according to the embodiment includes the main body 21 and the operation console 22.

The operation console 22 includes an activation control unit 23, an authentication control unit 24, a storage unit 25, and an authentication setting unit 30.

The activation control unit 23 performs an activation process in response to a power switch of the image forming apparatus 20 being switched ON. The image forming apparatus 20 enters a power-saving mode from a normal mode when the operation console 22 accepts no operation for a predetermined period. If the image forming apparatus 20 then returns to the normal mode, the activation control unit 23 also performs a process at that time.

The power-saving mode is a mode in which power consumption is less than that in the normal mode. The image forming apparatus 20 enters the power-saving mode from the normal mode in response to a period for which the operation console 22 accepts no operation exceeding a predetermined period or in response to a user operation performed on the operation console 22. The image forming apparatus 20 returns to the normal mode from the power-saving mode in response to a user operation performed on the operation console 22, for example.

In the case where the main body authentication setting is ON and the system authentication is set, the authentication control unit 24 uses an authentication function of the information processing apparatus 10 for main body authentication. Specifically, the authentication control unit 24 may be implemented as an authentication application that runs in the operation console 22 of the image forming apparatus 20.

In response to a user operation, the authentication control unit 24 performs a device registration process and an authentication process, for example. If authentication is successful, the authentication control unit 24 notifies a main body authentication unit 28 of the main body 21 of successful authentication.

In the case where the main body authentication setting is ON and the standard authentication is set, the authentication control unit 24 displays an authentication screen for main body authentication, and causes, in response to a user operation, the main body authentication unit 28 to perform an authentication process. In this case, the authentication control unit 24 does not communicate with the information processing apparatus 10.

The storage unit 25 stores various kinds of information. Specifically, the storage unit 25 stores password skip information 26.

The password skip information 26 is information indicating a user for whom omission of a password is permitted. Specifically, the authentication control unit 24 accepts selection of whether to omit a password from a user. In response to accepting selection to omit a password, the authentication control unit 24 writes information indicating the user in the password skip information 26.

In response to a user operation (usually, an operation by an administrator of the image forming apparatus 20), the authentication setting unit 30 sets main body authentication. Specifically, in response to an operation of selecting ON or OFF of the main body authentication setting and in response to, in the case of ON, an operation of selecting standard authentication or system authentication, the authentication setting unit 30 stores the input settings.

Specifically, in the case where the main body authentication setting is ON, if the main body authentication is successful, the operation console 22 displays a home screen in which a native app is be selected. In response to the operation console 22 accepting an operation of selecting a native app in the displayed home screen, a corresponding function of the image forming apparatus 20 is implemented.

The main body 21 includes a web application programming interface (API) service unit 27, the main body authentication unit 28, and an image forming unit 29.

The web API service unit 27 provides web APIs to the operation console 22. Web APIs are interfaces for using various functions of the main body 21. The web APIs include an API for acquiring a device identification number. In response to an API call from the operation console 22, the web API service unit 27 transmits the device identification number stored in the main body 21 to the operation console 22. The device identification number is a number for identifying the image forming apparatus 20.

The main body authentication unit 28 performs main body authentication. Specifically, in the case where the main body authentication setting is ON and the standard authentication is set, the main body authentication unit 28 performs a main body authentication process in response to a request from the authentication control unit 24 and determines whether the authentication is successful.

In the case where the main body authentication setting is ON and the system authentication is set, the main body authentication unit 28 determines that the main body authentication is successful in response to a notification indicating successful authentication from the authentication control unit 24 and permits processes for implementing various functions to be performed.

The image forming unit 29 performs image forming processes such as copying, scanning, faxing, and printing. In the case where the main body authentication setting is ON, the image forming unit 29 performs an image forming process on condition that authentication performed by the main body authentication unit 28 is successful.

Operations of the authentication system 1 will be described next with reference to the drawings.

It is assumed that the tenant information TI, the user information RI, and the like are stored in the storage unit 11 of the information processing apparatus 10.

The tenant information TI is information on a tenant. The tenant information TI is registered, updated, or deleted by a system administrator or the like via a tenant management screen. The term “tenant” refers to a group such as a company or an organization to which a user belongs. Specifically, the tenant information TI includes items such as a tenant ID and a tenant name. The tenant ID has, as a value, an identifier for identifying a tenant. The tenant name has, as a value, a name of the tenant.

The device information DI is information on a device. The device information DI is registered through a device registration process. A device in the embodiment is a device used by a plurality of users such as the image forming apparatus 20. The device information DI is managed by the system administrator or the like. Specifically, the device information DI includes items such as a device identification number. The device identification number has, as a value, an identifier for identifying a device.

The user information RI is information on a user. The user information RI is registered, updated, or deleted by the system administrator or the like. Specifically, the user information RI includes items such as a user ID, an email address, and a password. The user ID has, as a value, an identifier for identifying a user. The email address has, as a value, a character string of an email address. The password has, as a value, a character string of a password. The tenant information TI, the device information DI, and the user information RI may be stored in association with each other. This allows the information processing apparatus 10 to collect and manage the numbers of devices and users registered for a tenant, the use states, and the device states, for example.

The tenant information TI includes information indicating authentication methods. Specifically, the information processing apparatus 10 displays an authentication method setting screen in accordance with the information indicating the authentication methods included in the tenant information TI. The information processing apparatus 10 accepts an authentication method selection operation performed by a tenant administrator who manages settings for each tenant.

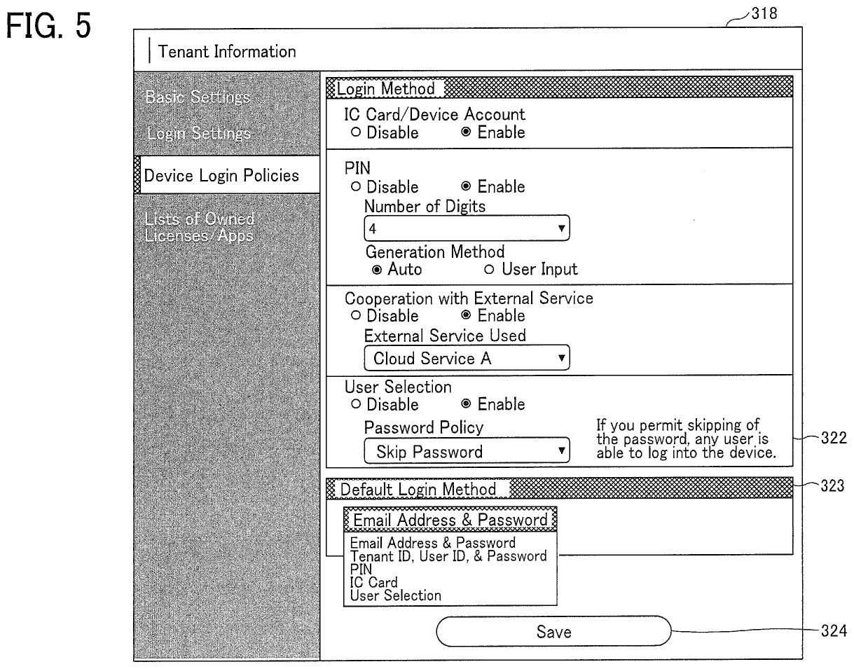

FIG. 5 is a diagram illustrating an example of the authentication method setting screen.

Data of an authentication method setting screen 318 is provided by a web application executed by the information processing apparatus 10. A terminal such as a personal computer (PC) used by the tenant administrator accesses the information processing apparatus 10 via a browser function to display the authentication method setting screen 318.

The authentication method setting screen 318 includes a user selection setting field 322 and a save button 324.

In the user selection setting field 322, the tenant administrator selects whether to enable an authentication method (hereinafter, referred to as a user selection authentication method) in which a user is selected. In response to enabling of the user selection authentication method, “User Selection” comes to be included in options in a default login method setting field 323.

In the user selection setting field 322, the tenant administrator selects whether to permit omission of a password in authentication. In the user selection setting field 322, an explanation about a risk of permitting omission of a password may be displayed.

In the default login method setting field 323, the tenant administrator selects a default authentication method of main body authentication. Options include “User Selection”.

In response to the tenant administrator pressing the save button 324, the information processing apparatus 10 reflects the content of the input settings in the tenant information TI stored in the storage unit 11.

Each user operates a terminal capable of communicating with the information processing apparatus 10 to input a user ID, an email address, and a password, for example. In this manner, each user is able to log in a management screen by using an account set for the user. The terminal operated by each user displays a management screen provided by a web application of the information processing apparatus 10.

The terminal operated by each user is capable of displaying the management screen and accepting an operation of, for example, confirming or modifying the user information RI such as the user ID, the email address, and the password.

A sequence of the main body authentication process will be described next.

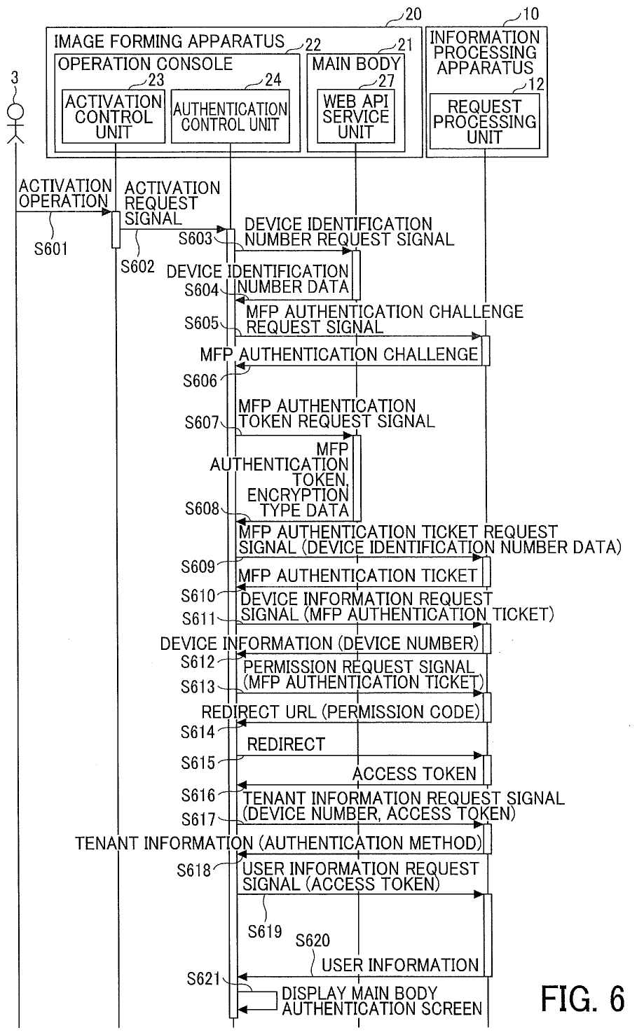

FIG. 6 is a sequence diagram illustrating an example of a main-body-authentication-screen display process.

It is assumed that the main body authentication setting of the image forming apparatus 20 is ON and the system authentication is set.

In response to a user 3 performing an operation for activating the image forming apparatus 20 (step S601), the activation control unit 23 of the operation console 22 transmits an activation request signal to the authentication control unit 24 (step S602). The authentication control unit 24 transmits a device identification number request signal to the main body 21 (step S603). The web API service unit 27 transmits device identification number data to the authentication control unit 24 (step S604).

The authentication control unit 24 then transmits an MFP authentication challenge request signal to the information processing apparatus 10 (step S605). The MFP authentication challenge request signal is a signal for requesting issuance of an MFP authentication challenge. An MFP authentication challenge is a data string generated each time based on a random number to perform authentication of the image forming apparatus 20 such as an MFP (hereinafter, referred to as MFP authentication) and is a type of one-time password used in so-called challenge-response authentication technology.

The information processing apparatus 10 performs MFP authentication in processing up to step S610 below to transmit the device information DI to the image forming apparatus 20.

The request processing unit 12 issues an MFP authentication challenge and transmits the MFP authentication challenge to the image forming apparatus 20 (step S606). The authentication control unit 24 transmits an MFP authentication token request signal to the web API service unit 27 (step S607). The MFP authentication token request signal is a signal for requesting issuance of an MFP authentication token. The MFP authentication token request signal includes the MFP authentication challenge.

The web API service unit 27 transmits an MFP authentication token and encryption type data to the authentication control unit 24 (step S608). The MFP authentication token is a character string encrypted based on the device information DI. The encryption type data is data indicating an encryption type used by the web API service unit 27 in creation of the MFP authentication token.

The authentication control unit 24 transmits an MFP authentication ticket request signal to the information processing apparatus 10 (step S609). The MFP authentication ticket request signal is a signal for requesting issuance of an MFP authentication ticket and includes the device identification number data acquired in step S604. The MFP authentication ticket is data indicating that MFP authentication is successful.

The request processing unit 12 performs MFP authentication and transmits an MFP authentication ticket to the image forming apparatus 20 (step S610). The authentication control unit 24 transmits a device information request signal to the information processing apparatus 10 (step S611). The device information request signal includes the MFP authentication ticket.

The request processing unit 12 transmits the device information DI to the image forming apparatus 20 (step S612). The device information DI includes a device number for identifying the image forming apparatus 20.

In response to receipt of the device information DI, the authentication control unit 24 transmits a permission request signal to the information processing apparatus 10 (step S613). The permission request signal is a signal for requesting the information processing apparatus 10 to permit transmission of the tenant information TI. The permission request signal includes the MFP authentication ticket.

The request processing unit 12 transmits a redirect Uniform Resource Locator (URL) including a permission code indicating that transmission is permitted, to the image forming apparatus 20 (step S614). The authentication control unit 24 is redirected to the redirect URL (step S615). The redirect URL is a URL for issuance of an access token of the information processing apparatus 10.

The access token is an encrypted character string used for requesting transmission of the tenant information TI. The request processing unit 12 generates an access token and transmits the access token to the image forming apparatus 20 (step S616).

The authentication control unit 24 transmits a tenant information request signal to the information processing apparatus 10 (step S617). The tenant information request signal is a signal for requesting transmission of the tenant information TI. The tenant information request signal includes the device number included in the device information DI acquired in step S612 and the access token acquired in step S616.

The request processing unit 12 transmits the tenant information TI to the image forming apparatus 20 (step S618). The tenant information TI includes the authentication method(s) set in the authentication method setting screen 318 described above.

If the authentication method included in the tenant information TI indicates “User Selection”, the authentication control unit 24 transmits a user information request signal to the information processing apparatus 10 (step S619). The user information request signal is a signal for requesting transmission of the user information RI. The user information request signal includes the access token acquired in step S616. The user information request signal au also include information for specifying the display order, the number of pages, the initial, or the like.

The request processing unit 12 acquires user information list data from the user information RI stored in the storage unit 11 in accordance with the specifying information, and transmits the user information RI to the image forming apparatus 20 (step S620).

The authentication control unit 24 displays a main body authentication screen in accordance with the received user information RI (step S621).

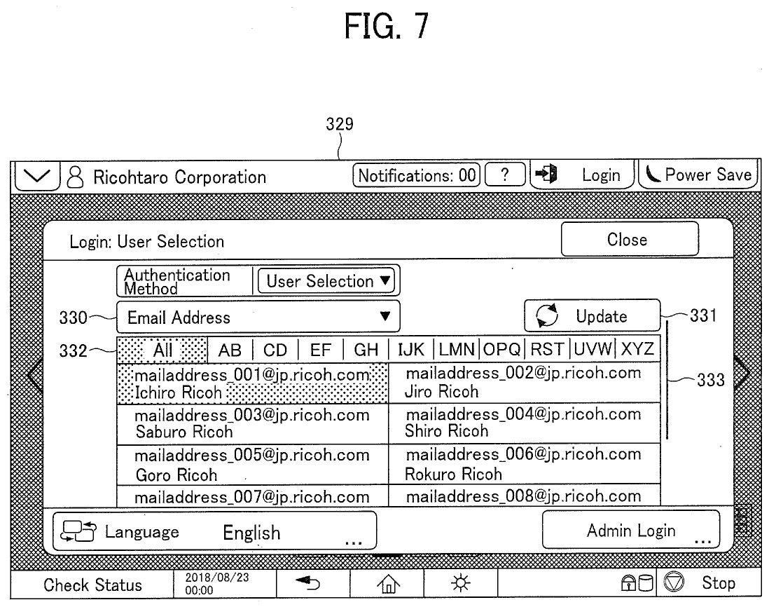

FIG. 7 is a diagram illustrating an example of the main body authentication screen.

A main body authentication screen 329 is a screen in which a list of users authorized to log in is displayed and in which a user to log in is selected from the displayed list. Specifically, the main body authentication screen 329 includes a display order selection field 330, an update button 331, an index selection tab 332, and a scroll bar 333.

The display order selection field 330 is a graphical user interface (GUI) for changing the display order. In response to the display order being changed, the authentication control unit 24 displays a list of users in the new display order. “All” is selected at the index selection tab 332.

The update button 331 is a GUI for displaying the latest list of users. In response to the update button 331 being pressed, the authentication control unit 24 performs a user information update process described below. “All” is selected at the index selection tab 332.

The index selection tab 332 is a GUI for selecting, in the case where the display order is an order of email addresses, the initial of the email addresses to limit email addresses to be displayed on the screen. In the case where the display order is an order of user IDs, the initial of the user IDs may be selected.

The scroll bar 333 is a GUI for scrolling the list of users displayed on the screen.

In response to each of the GUIs described above being operated, the authentication control unit 24 performs a process defined by a program written in a script language to modify the input item.

In response to the update button 331 being pressed in the main body authentication screen 329, the authentication control unit 24 starts the user information update process.

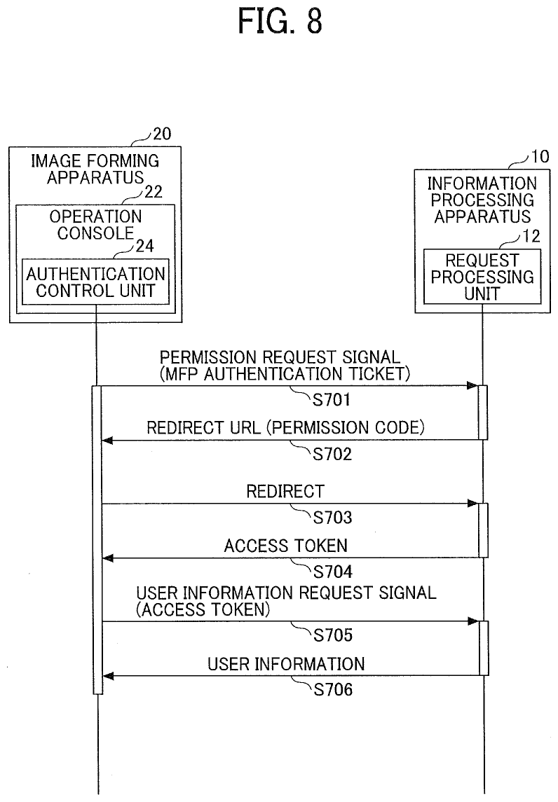

FIG. 8 is a sequence diagram illustrating an example of the user information update process.

The authentication control unit 24 transmits a permission request signal to the information processing apparatus 10 (step S701). The permission request signal includes the MFP authentication ticket. The request processing unit 12 transmits, to the image forming apparatus 20, a redirect URL including a permission code indicating that permission is given (step S702).

The authentication control unit 24 is redirected to the redirect URL (step S703). The redirect URL is a URL for issuance of an access token of the information processing apparatus 10. The request processing unit 12 generates an access token and transmits the access token to the image forming apparatus 20 (step S704).

The authentication control unit 24 transmits a user information request signal to the information processing apparatus 10 (step S705). The user information request signal is a signal for requesting transmission of the user information RI. The user information request signal includes the access token acquired in step S704. The user information request signal also includes information for specifying the display order, the number of pages, the initial, or the like.

The request processing unit 12 acquires user information list data from the user information RI stored in the storage unit 11 in accordance with the specifying information, and transmits the user information RI to the image forming apparatus 20 (step S706). In response to receipt of the user information RI, the authentication control unit 24 of the image forming apparatus 20 displays the main body authentication screen including the received user information RI.

In response to acceptance of selection of the user 3 who is to log in, the image forming apparatus 20 uses the user ID indicating the selected user 3 as input information and performs the main body authentication process.

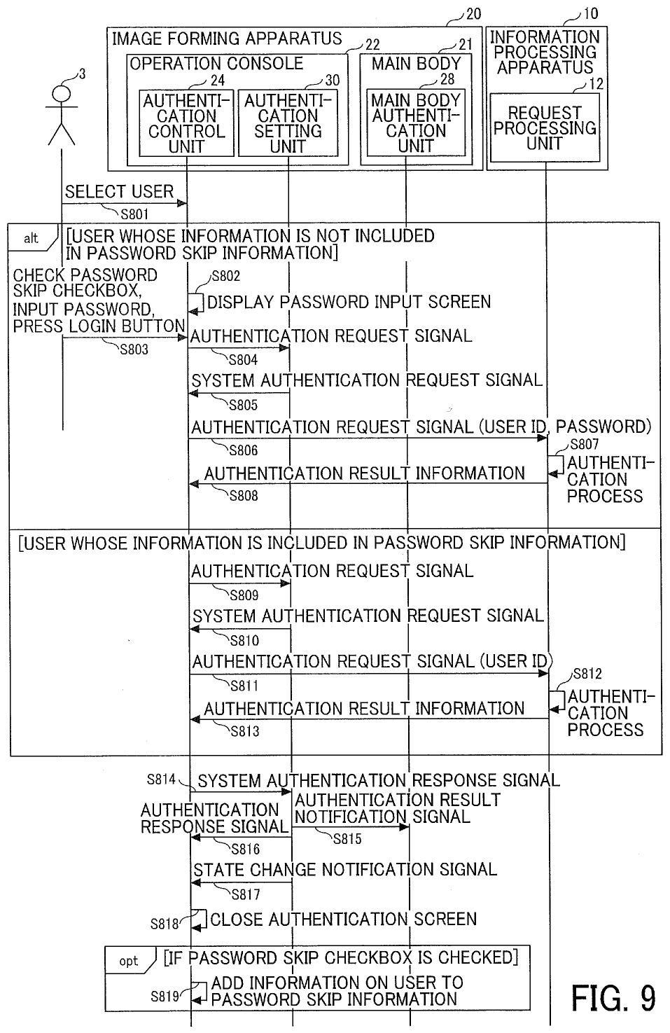

FIG. 9 is a sequence diagram illustrating an example of the main body authentication process.

The authentication control unit 24 of the image forming apparatus 20 accepts selection of a user that is performed by the user 3 via the main body authentication screen (step S801). The authentication control unit 24 determines whether information on the selected user is included in the password skip information 26.

If the authentication control unit 24 determines that information on the selected user is not included in the password skip information 26, the authentication control unit 24 causes a display to display a password input screen (step S802).

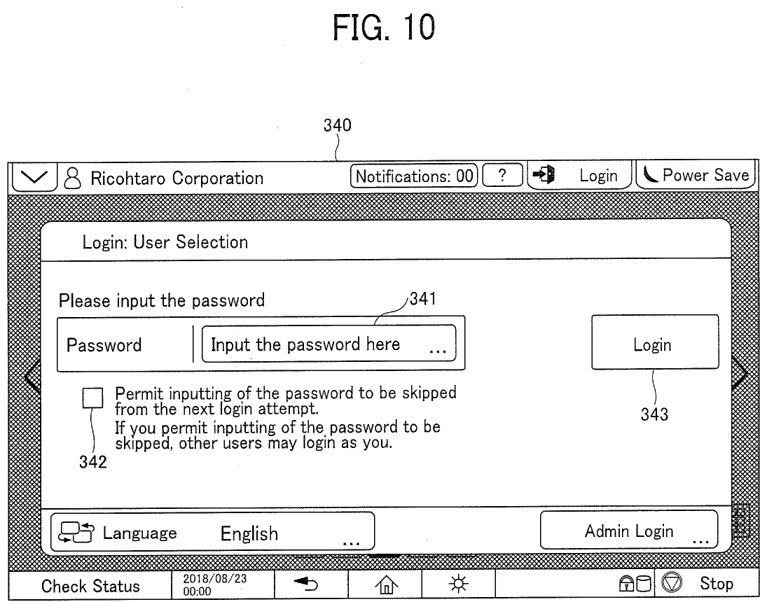

FIG. 10 is a diagram illustrating an example of the password input screen.

A password input screen 340 includes a password input field 341, a password skip checkbox 342, and a login button 343.

The password input field 341 is an input field to which text indicating the password of the selected user is to be input.

The password skip checkbox 342 is a checkbox for selecting whether to omit input of the password when the selected user attempts to log in next and subsequent times.

The login button 343 is a button for transmitting the text input to the password input field 341 and the selected content of the password skip checkbox 342 to perform user authentication.

Referring back to FIG. 9, in response to the login button 343 being pressed (step S803), the authentication control unit 24 transmits an authentication request signal to the authentication setting unit 30 (step S804). In the case where the main body authentication is ON and the system authentication is set, the authentication setting unit 30 transmits a signal for requesting the system authentication (system authentication request signal) to the authentication control unit 24 (step S805).

The authentication control unit 24 transmits an authentication request signal to the information processing apparatus 10 (step S806). The authentication request signal includes the user ID indicating the user selected in step S801 and the password input in the step S803.

Based on the user ID and the password, the request processing unit 12 performs an authentication process (step S807). The request processing unit 12 transmits information indicating the authentication result (authentication result information) to the image forming apparatus 20 (step S808). If authentication is unsuccessful in the authentication process, the request processing unit 12 transmits, for example, a Hypertext Transfer Protocol (HTTP) status code of 400, 401, 402, or the like to the image forming apparatus 20.

Subsequently to step S801, if the authentication control unit 24 determines that information on the selected user is included in the password skip information 26, the authentication control unit 24 does not display the password input screen and transmits an authentication request signal to the authentication setting unit 30 (step S809). In the case where the main body authentication is ON and the system authentication is set, the authentication setting unit 30 transmits a system authentication request signal to the authentication control unit 24 (step S810).

The authentication control unit 24 transmits an authentication request signal to the information processing apparatus 10 (step S811). The authentication request signal includes the user ID indicating the user selected in step S801.

Based on the user ID, the request processing unit 12 preforms an authentication process (step S812). The request processing unit 12 transmits authentication result information to the image forming apparatus 20 (step S813).

Specifically, in the case where authentication setting information included in the tenant information TI indicates that omission of the password is not permitted, the request processing unit 12 transmits information indicating unsuccessful authentication to the image forming apparatus 20 since the password is not included in the authentication request signal. If authentication is unsuccessful in the authentication process, the request processing unit 12 transmits, for example, an HTTP status code of 400, 401, 402, or the like to the image forming apparatus 20.

Conversely, in the case where the authentication setting information included in the tenant information TI indicates that omission of the password is permitted and where information on the user identified by the user ID is included in the user information RI, the request processing unit 12 transmits information indicating successful authentication to the image forming apparatus 20.

Subsequently to step S808 or step S813, the authentication control unit 24 transmits a system authentication response signal to the authentication setting unit 30 (step S814). The system authentication response signal is a signal that serves as a response to the system authentication request signal transmitted in step S805 or step S810 and that notifies the authentication setting unit 30 of a result of the authentication. The authentication setting unit 30 transmits an authentication result notification signal to the main body authentication unit 28 (step S815) and transmits an authentication response signal to the authentication control unit 24 (step S816).

The authentication response signal is a signal indicating a response to the authentication request signal transmitted in step S804 or step S809. The authentication result included in the system authentication response signal transmitted in step S814 is reflected in the content of the response.

The authentication setting unit 30 transmits a state change notification signal to the authentication control unit 24 (step S817). The state change notification signal is a signal for notifying the authentication control unit 24 of a change in the login state. For example, in the case where authentication is successful in the authentication process, the state change notification signal indicates that the state has changed from a logout state to a login state. Conversely, in the case where authentication is unsuccessful in the authentication process, the state change notification signal indicates that the logout state remains unchanged.

If the state change notification signal indicates a change from the logout state to the login state, the authentication control unit 24 closes the authentication screen (step S818). Consequently, the home screen is displayed on the operation console 22. Thus, apps such as native apps and browser apps are selectable.

Subsequently, if the password skip checkbox 342 in the password input screen 340 is checked, the authentication control unit 24 adds information on the selected user to the password skip information 26. Consequently, the user 3 is permitted to skip inputting of the password at the time of the next and subsequent login attempts.

In response to the authentication screen being closed in step S818, the operation console 22 displays the home screen.

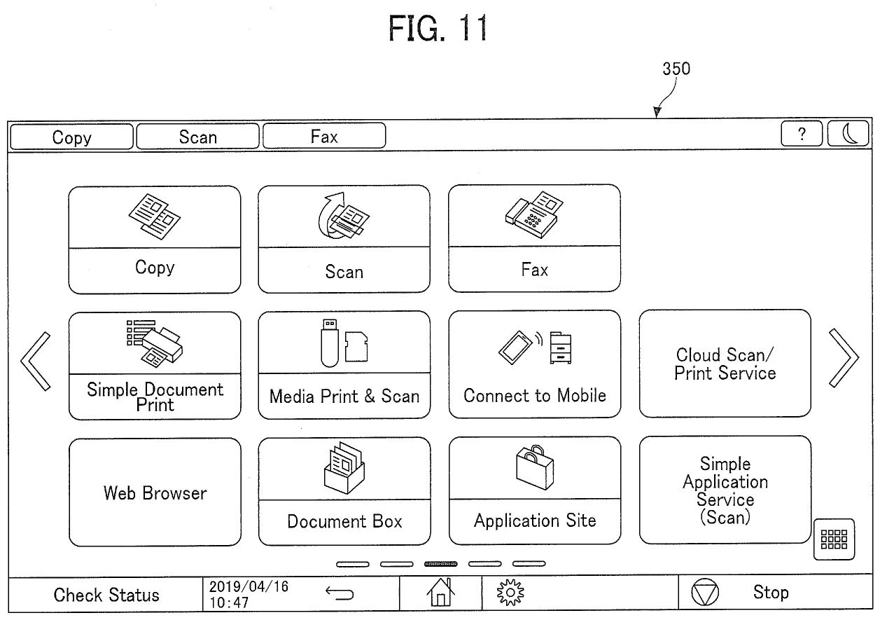

FIG. 11 is a diagram illustrating an example of the home screen.

A home screen 350 is a screen in which a function is selected from among various functions of the image forming apparatus 20 and various functions provided by the information processing apparatus 10.

For example, the home screen 350 displays icons for starting applications that implement various image forming functions (such as copying, scanning, and faxing) of the image forming apparatus 20. For example, the home screen 350 displays icons of “Copy”, “Scan”, “Fax”, “Simple Document Print” (pull printing of data in an on-premise server), “Media Print”, and “Document Box” (storage of scanned data or the like).

The home screen 350 also displays an icon such as “Application Site” for displaying a list of applications available at an application site provided by the information processing apparatus 10.

The home screen 350 also displays icons such as “Cloud Scan/Print Service” and “Simple Application Service”. These icons are for starting services that are cloud services applied by the tenant and that are available in this device. These icons include URLs of websites. In response to one of these icons being selected, a web browser is started.

Thus, if authentication not using the password is successful in the information processing apparatus 10, the image forming apparatus 20 makes applications of the information processing apparatus 10 for implementing the image forming functions of the image forming apparatus 20 as well as the applications of the image forming apparatus 20 available in the image forming apparatus 20.

If the authentication result information received by the image forming apparatus 20 in step S808 or step S813 of the main body authentication process illustrated in FIG. 9 indicates unsuccessful authentication, the operation console 22 displays an authentication error screen.

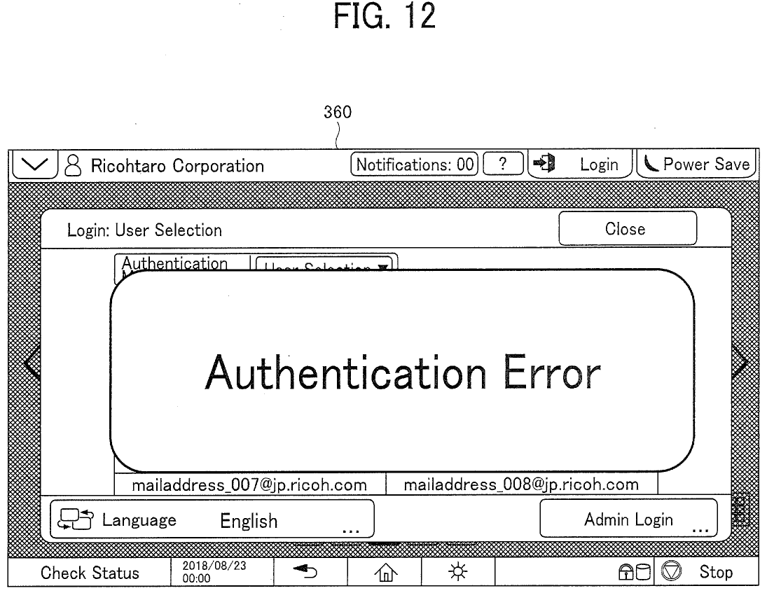

FIG. 12 is a diagram illustrating an example of the authentication error screen.

An authentication error screen 360 includes a message indicating that authentication is unsuccessful. All the various functions displayed in the home screen 350 described above are made unavailable.

Thus, if authentication not using the password is unsuccessful in the information processing apparatus 10, the image forming apparatus 20 makes the applications of the information processing apparatus 10 as well as the applications of the image forming apparatus 20 unavailable in the image forming apparatus 20.

In the authentication error screen 360, some of the functions described above may be made available. For example, icons for starting applications that implement the various image forming functions (such as copying, scanning, and faxing) of the image forming apparatus 20 alone may be displayed. An icon for displaying a list of applications available at an application site provided by the information processing apparatus 10 may be further displayed.

If the authentication error screen 360 is a screen that permits the use of some of the functions described above, which functions are to be made available may be set in the information processing apparatus 10.

In the authentication system 1 according to the embodiment, the request processing unit 12 of the information processing apparatus 10 receives an authentication request signal from the image forming apparatus 20. The authentication request signal includes an identifier for identifying a user but does not include a password. If setting information indicates omission of the password is not permitted, the request processing unit 12 transmits information indicating unsuccessful authentication to the image forming apparatus 20. If the setting information indicates omission of the password is permitted and if user information includes information on the user identified by the identifier, the request processing unit 12 transmits information indicating successful authentication to the image forming apparatus 20.

Thus, setting the permission for omission of the password allows a user to skip inputting of the password. Consequently, the convenience improves. Since an authentication file such as a cookie is not used instead, authentication can be performed even if a plurality of users use the device.

In particular, in the case where an influence of erroneous authentication of a user or spoofing is small such as in the case where the authentication function is used merely for distinguishing the operation logs between users, a reduced security level due to omission of the password is not so problematic. Thus, an authentication operation performed by the user to distinguish between the users can be simplified.

The authentication control unit 24 accepts selection of whether to omit the password from a user. In response to accepting selection to omit the password, the authentication control unit 24 writes information indicating the user in the password skip information 26. In response to accepting an operation for specifying a user whose information is included in the password skip information 26, the authentication control unit 24 transmits, to the information processing apparatus 10, an authentication request signal that includes an identifier for identifying the user but does not include a password.

Thus, since whether to omit the password can be selected for each user, a flexible operation according to different wishes of different users can be implemented. Depending on the operation method, selection of whether to omit the password may be omitted. Thus, in such a case, the password may be omitted indiscriminately.

In the embodiment described above, the example of omitting the password in the authentication screen of the user selection method has been described. The scope of the present disclosure is not limited to this, and the password may be omitted in an authentication screen other than the authentication screen of the user selection method. For example, in an authentication screen in which the user ID, the email address, and the password are input, the user may skip inputting the password and may be prompted to input the user ID and the email address alone and authentication may be performed.

The group of apparatuses described in the above embodiment is merely one example of a plurality of computing environments in which the embodiment disclosed herein is carried out.

In one embodiment, the information processing apparatus 10 may be configured as an information processing system that includes a plurality of computing devices (information processing apparatuses) such as server clusters and that provides services such as cloud services and web services. The plurality of computing devices may be configured to communicate with each other via a communication link of any type including a network, shared memory, or the like and may perform the processes disclosed herein.

The information processing apparatus 10 and the image forming apparatus 20 may be configured to share the disclosed processing steps, for example, steps of FIG. 6, 8, or 9 in various combinations. The components of the information processing apparatus 10 (or the information processing system) and the components of the image forming apparatus 20 may be collectively included in a single server apparatus or may be distributed to a plurality of apparatuses. For example, different information processing apparatuses having the various functional units, such as an information processing apparatus storing the user information RI and the information processing apparatus having web applications for providing various functions may operate in cooperation with each other to constitute an information processing system.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

In the embodiment described above, the image forming apparatus 20 is described as an example of a device. However, the device is not limited to the image forming apparatus and may be any device having a communication function. Other examples of the device may include an output device such as a projector (PJ) or a digital signage, a head-up display (HUD), an industrial machine, a medical device, a networked home appliance, an automobile (connected car), a laptop PC, a mobile phone, a tablet terminal, a game console, a personal digital assistant (PDA), a digital camera, a wearable PC, and a desktop PC.

The application programs such as the native apps and the browser apps of the image forming apparatus 20 may be installed on an information processing apparatus such as a PC, a mobile terminal, or a smartphone of a user. That is, the operation console 22 described above may be included in an apparatus different from the image forming apparatus 20.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

In one embodiment of the present disclosure, an information processing apparatus includes circuitry, and one or more memories configured to store user information and setting information that indicates whether omission of a password is permitted in authentication. The circuitry is configured to receive, from a device, an authentication request signal that includes an identifier for identifying a user but does not include a password. The circuitry is configured to, in response to the setting information in the one or more memories indicating that omission of the password is permitted and in response to the user information including information on the user identified by the identifier, transmit information indicating successful authentication to the device.

1. An authentication system comprising:
a device; and
at least one information processing apparatus connected to the device via a network, the information processing apparatus including:
one or more memories that store user information and setting information indicating whether omission of a password is permitted in authentication; and
first circuitry configured to
receive, from the device, an authentication request signal that includes an identifier for identifying a user but does not include a password, and
in response to the setting information indicating that omission of the password is permitted and in response to the user information including information on the user identified by the identifier, transmit information indicating successful authentication to the device, and
the device including:
second circuitry configured to transmit, to the information processing apparatus, the authentication request signal that includes an identifier for identifying a user but does not include a password.

2. The authentication system according to claim 1,
wherein the device further includes:
a memory that stores password skip information indicating a user for whom omission of a password is permitted,
wherein the second circuitry is configured to
in response to accepting selection of to omit the password from the user, write information indicating the user in the password skip information, and
in response to accepting an operation for specifying a user whose information is included in the password skip information, transmit the authentication request signal that includes the identifier for identifying the user but does not include the password to the information processing apparatus.

3. The authentication system according to claim 2,
wherein the second circuitry is configured to
control a display to display a password input screen including a selection field for accepting the selection of whether to omit the password and an input field for inputting a password, and
transmit an authentication request signal that includes the password input in the input field and the identifier to the information processing apparatus,
wherein the first circuitry is configured to
in response to receiving, from the device, the authentication request signal that includes the identifier and the password, perform an authentication process in accordance with the identifier and the password, and
transmit an authentication result to the device, and
wherein the second circuitry is configured to
in response to receiving the information indicating successful authentication from the information processing apparatus and in response to the selection being the selection to omit the password, write the information indicating the user in the password skip information.

4. The authentication system according to claim 2,
wherein the first circuitry is configured to transmit the user information to the device, and
wherein the second circuitry is configured to
receive the user information,
control a display to display an authentication screen including a list of users from which a user whose information is included in the received user information is to be selected, and
in response to selection of a user whose information is included in the password skip information, transmit the authentication request signal that includes the identifier for identifying the user but does not include the password to the information processing apparatus.

5. The authentication system according to claim 1, further comprising:
a terminal capable of communicating with the information processing apparatus,
wherein the terminal includes:
third circuitry configured to transmit, to the information processing apparatus, a request for changing a setting of whether to permit omission of a password in authentication, the setting being included in the setting information, the request being a request from the device, and
wherein the first circuitry of the information processing apparatus is configured to, in response to receiving the request for changing the setting from the terminal, change the setting information.

6. The authentication system according to claim 1,
wherein the second circuitry of the device is configured to
in response to authentication not using the password being successful in the information processing apparatus, make an application of the information processing apparatus and an application of the device available in the device, the application of the information processing apparatus being an application for implementing an image forming function of the device, and
in response to authentication not using the password being unsuccessful in the information processing apparatus, make the application of the information processing apparatus and the application of the device unavailable in the device.

7. A device comprising:
a memory that stores password skip information indicating a user for whom omission of a password is permitted; and
circuitry configured to
in response to accepting selection to omit a password from a user, write information indicating the user in the password skip information, and
in response to accepting an operation for specifying a user whose information is included in the password skip information, transmit an authentication request signal that includes an identifier for identifying the user but does not include a password to an information processing apparatus.

8. The device according to claim 7,
wherein the circuitry is configured to receive information indicating successful authentication from the information processing apparatus, and
wherein the information indicating successful authentication is generated, along with setting information indicating that omission of a password is permitted, in response to user information stored in the information processing apparatus including information on the user identified by the identifier.

9. A method for authenticating a user who is to use a device, the method being performed by the device, the method comprising:
storing password skip information in a memory, the password skip information being information that indicates a user for whom omission of a password is permitted;
writing, in response to accepting selection to omit a password from a user, information indicating the user in the password skip information; and
transmitting, in response to accepting an operation for specifying a user whose information is included in the password skip information, an authentication request signal that includes an identifier for identifying the user but does not include a password to an information processing apparatus.

10. The method according to claim 9, further comprising:
receiving information indicating successful authentication from the information processing apparatus,
wherein the information indicating successful authentication is generated, along with setting information indicating that omission of a password is permitted, in response to user information stored in the information processing apparatus including information on the user identified by the identifier.
